(19) United States
(12) Patent Application Publication
(10) Pub. No.: US 2004/0157111 A1
(43) Pub. Date: Aug. 12, 2004

(54) Fuel cell

(76) Inventors: Shigeru Sakamoto, Osaka (JP); Yasunori Yoshimoto, Osaka (JP); Yoshihiro Ikoma, Osaka (JP)

Correspondence Address: MCDERMOTT, WILL & EMERY, 600 13th Street, N.W., Washington, DC, 20005-3096, US

(21) Appl. No.: 10/722,122

(22) Filed: Nov. 26, 2003

(30) Foreign Application Priority Data
Nov. 28, 2002 (JP) 2002-346298
Dec. 2, 2002 (JP) 2002-350543

(51) Int. Cl. H01M 4/94; H01M 8/10

(52) U.S. Cl. 429/44; 429/32; 429/30; 429/38

(57) ABSTRACT

A fuel cell is capable of suppressing the deterioration and instability in the performance which result from the plugging of water in separators as well as the reduction of the service life of cell units, and further the single fuel cell is capable of preventing the reactant gas from flowing into the adjacent gas flow channels via gas diffusion layers, so that the reaction uniformly takes place in the surface of electrodes, thereby enabling a rated electric power to be obtained.

A fuel electrode catalyst layer 3 and an air electrode catalyst layer 2 are disposed on both surfaces of an electrolyte membrane 1, and gas diffusion layers 5, 4 are further disposed on the outer surface of the electrode catalyst layers 3, 2 respectively, and a pair of separators 10 having gas flow channels 8 for reactant gas, each of said separators being disposed so as to face the gas diffusion layers 5, 4, so that the fuel cell is produced by laminating single cells, each of which is formed by fastening the above layer elements between the separators. In this case, the pressure loss in the case when the reactant gas flows into adjacent gas flow channels 8 may be set to be greater than the pressure loss in the case when water stayed in the gas flow channels 8 is blown away by the reactant gas.

A fuel electrode catalyst layer 3 and an air electrode catalyst layer 2 are disposed on both surfaces of an electrolyte membrane 1, and gas diffusion layers 5, 4 are further disposed on the outer surface of the electrode catalyst layers 3, 2 respectively, and a pair of separators 10 having concave portions and convex portions 20 to form gas flow channels 8 for reactant gas, each separators 10 being disposed on the gas diffusion layer so as to face the gas diffusion layer, so that the fuel cell is produced by laminating one or more members, i.e., single cells, each of which is formed by fastening the electrolyte membrane 1, catalyst layers 2, 3 and gas diffusion layers 4,5 to be clamped between the convex portions 20 of the separators 10. In this case, the gas diffusion layers are selected such that D2 is D1×0.9 or smaller, where D1 is the thickness of the gas diffusion layer before fastened between the separators and that D2 is the thickness of the gas diffusion layer after fastened between the separators.

### BACKGROUND OF THE INVENTION

1. Field of the Invention

The present invention relates to a fuel cell.

2. Description of the Related Art

FIG. 6 is an exploded sectional view of a solid polymer type fuel cell (single cell) for showing the basic structure of electrodes as an embodiment of a conventional fuel cell. An air electrode (cathode) catalyst layer 2 including noble metals (typically platinum) and a fuel electrode (anode) catalyst layer 3 are deposited onto the main surfaces of a solid polymer electrolyte membrane 1 on both sides thereof. Moreover, a gas diffusion layer 4 for the air electrode and another gas diffusion layer 5 for the fuel electrode are disposed so as to face the air electrode catalyst layer 2 and the fuel electrode catalyst layer 3, respectively (this arrangement is called as a cell unit), so that the air electrode 6 and the fuel electrode 7 are arranged. An oxidant gas and fuel gas pass through the gas diffusion layers 4 and 5, respectively, and, at the same time, the layers further serve to conduct an electric current to the outside. Moreover, a set of separators 10 made of an electrical conductive gas impermeable material is disposed in the fuel cell. The separator 10 has a plurality of concave portions and convex portions 20 forming gas flow channels 8 for reactant gas on one main surface and disposed on the outer surface of the gas diffusion layer 4 or 5 to face the gas diffusion layer, and the separator 10 has cooling water flow channels 9 on the opposite main surface. Accordingly, a fuel cell unit 11 (single fuel cell) is formed by fastening the electrolyte membrane 1, catalyst layers 2, 3 and gas diffusion layers 4, 5, all together by the convex portions 20.

FIG. 7 is a sectional view of a solid polymer type fuel cell stack in the basic structural arrangement. In this case, a plurality of fuel cell electrodes 11 (single fuel cell) is laminated, and they are clamped together with current collector plates 12 and isolation plates 13 used for both electrical isolation and thermal isolation by fastening plates 14 for applying a fastening pressure to maintain the laminated state. The fuel cell electrodes 11 are fastened by bolts 15 and nuts 17, and the fastening pressure is applied by disk springs 16.

A proton exchange group is contained in each molecule of the solid polymer electrolyte membrane 1. The saturated water content provides a specific resistance of 200 Ωcm² or less at a normal temperature, so that the membrane 1 serves as a proton conductive electrolyte. The solid polymer type fuel cell is normally operated by supplying a wet reactant gas containing saturated water vapor to each fuel cell unit 11 (single fuel cell), since the solid polymer electrolyte membrane 1 functions as a proton conductive electrolyte when it contains water.

When a fuel gas containing hydrogen is supplied to the fuel electrode 7 and, at the same time, when an oxidant gas containing oxygen is supplied to the air electrode 6, an electrochemical reaction, i.e., the fuel electrode reaction, takes place on the fuel electrode 7, where a hydrogen molecule is decomposed into two hydrogen ions and two electrons, and similarly another electrochemical reaction, i.e., the air electrode reaction, takes place on the air electrode 6, where a water molecule is generated from an oxygen atom, two hydrogen ions and two electrons. As a result, an electric power is conveyed to a load by electrons moving from the fuel electrode to the air electrode via an external circuit, along with the generation of water on the side of the air electrode.

Fuel electrode; H₂→2H⁺+2e⁻ (fuel electrode reaction)

Air electrode; 2H⁺+(½)O₂+2e⁻→H₂O (air electrode reaction)

Total; H₂+(½)O₂→H₂O

Hence, water is generated on the side of the air electrode 6, and further there exists water which moves to the air electrode 6 in accordance with the movement of hydrogen ions from the side of the fuel electrode 7.

As a result, the following functions are required for the gas diffusion layers 4 and 5: 1) The reactant gas supplied from the concave portions forming the gas flow channels 8 for flowing the reactant gas is uniformly supplied to the catalyst layers 2 and 3; 2) The electric current is conducted to the outside; and 3) The discharge of the water generated in the reaction and the moving water from the catalyst layers 2, 3 and the supply of the water from the reactant gas containing the saturated water vapor to the solid polymer electrolyte membrane 1 and catalyst layers 2, 3 are controlled in a proper state.

For this purpose, an electrically conductive porous material including porous elements composed of carbon paper, carbon fiber woven fabric, carbon non-woven fabric or metallic fibers; or a material produced by applying the water repellent finish to the electrically conductive porous material; or a material produced by coating a mixture of carbon powder and a water repellent agent on the electrically conductive porous material is used for the gas diffusion layers 4 and 5 (for example, see U.S. PT. No. 6,083,638 and U.S. PT. No. 6,127,059).

However, there are problems in the conventional fuel cell unit 11 (single fuel cell). As shown in FIG. 8, part of the reactant gas flowing in the gas flow channel 8 flows via, for example, the gas diffusion layer 5 clamped between the convex portions 20 into adjacent gas flow channels 8, as indicated by white arrow, thereby causing the reactant gas not to uniformly flow in the gas flow channels 8. When the reactant gas does not flow in the gas flow channels 8, an electric power is not generated in a sufficiently high efficiency in the surface of the electrodes, thereby making it impossible to generate the rated electric power. In addition, water droplets generated by the condensation of saturated water vapor in the reactant gas as well as the water resulting from the reaction and the moving water which are discharged from the catalyst layers 2, 3, stay inside the gas flow channels 8, thereby making it impossible to discharge the droplets therefrom.

When, moreover, a wet reactant gas is supplied to the separators 10, the dew point increases due to a change in the operation condition of the fuel cell, an increased/decreased change in the amount of the reactant gas and a change in the temperature of the separators 10, thereby causing the water vapor in the reactant gas to be condensed. As a result, there appears a possible problem that the flow of the reactant gas is hindered, because the condensed droplets are deposited onto the inner surface of the gas flow channels 8 in the separators 10, and further the gas flow channels are clogged up with the droplets.

In this case, the reactant gas thus hindered flows into the adjacent gas flow channels 8 via the gas diffusion layer 5, so that the condensed water droplets are not discharged therefrom and continuously hinders the flow of the reactant gas. When the reactant gas flow is hindered, the amount of the reactant gas to be supplied to the electrodes is reduced, so that the electrochemical reaction is not fully carried out, hence causing the performance and the stability of the cell to be deteriorated, and further the service life of the cell unit to be reduced.

### SUMMARY OF THE INVENTION

Accordingly, it is an object of the present invention to provide a fuel cell which is capable of preventing the performance and stability of the cell from deteriorating as well as the service life of the cell unit from reducing, in which case, these drawbacks result from the water plugging in the separators.

It is another object of the present invention to provide a fuel cell which is capable of preventing the reactant gas from flowing into the adjacent gas flow channels 8 via the gas diffusion layer 5 clamped by the convex portions 20, so that the rated electric power can be obtained by the uniform reaction inside the electrode surface, and the droplets condensed in the gas flow channels 8 can be discharged therefrom even if the droplets stay therein.

To overcome the above problems in the prior art, the following solutions are provided:

In a first aspect of the present invention, a fuel cell is integrated by laminating one or more single cells in the form of a single unit, the single cell comprising: an electrolyte membrane; a fuel electrode catalyst layer disposed on one surface of said electrolyte membrane; an air electrode catalyst layer disposed on the other surface of the electrolyte membrane; a first gas diffusion layer disposed on the outer surface of the fuel electrode catalyst layer; a second gas diffusion layer disposed on the outer surface of the air electrode catalyst layer; a first separator having a plurality of gas flow channels for reactant gas, the first separator being in contact with the outer surface of the first gas diffusion layer; a second separator having a plurality of gas flow channels for reactant gas, the second separator being in contact with the outer surface of the second diffusion layer; wherein the fuel cell is formed by clamping said layer elements between the first and second separators to fasten said layer elements all together, wherein the fuel cell is equipped with means for restraining a reactant gas flowing into adjacent gas flow channels via the first or the second gas diffusion layer in order to prevent the generation of water droplets plugging the gas flow channels.

In a second aspect of the present invention, it is further included in the first aspect of the present invention that the generation of water droplets plugging the gas flow channels is suppressed by setting the pressure loss of the reactant gas flowing into adjacent gas flow channels via the gas diffusion layer greater than the pressure loss of the reactant gas blowing away the water stayed in the gas flow channels.

In a third aspect of the present invention, it is further included in the first aspect of the present invention that in the first gas diffusion layer and/or in said second gas diffusion layer, the gas permeability in the direction perpendicular to the gas flow direction and parallel to the surface of the separators is smaller than the gas permeability in the gas flow direction and in the lamination direction of the single cells.

In a fourth aspect of the present invention, it is further included in one of the first to third aspects that the first and second gas diffusion layers include fibrous elements, and wherein the gas flow direction in the gas flow channels is approximately parallel to the fiber direction of the fibrous elements in the first and second gas diffusion layers facing the gas flow channels.

In a fifth aspect of the present invention, it is further included in one of the first to third aspects that the first and second gas diffusion layers include fibrous elements, and wherein the gas flow direction for the gas flow channels possessing 50% or more areas of all the gas flow channels in the separator is arranged approximately parallel to the fiber direction of the fiber elements in the gas diffusion layers facing the separator.

In a sixth aspect of the present invention, it is further included in one of the first to third aspects that the first and second gas diffusion layers include fibrous elements, and wherein the gas flow direction in the separator is arranged approximately parallel to the fiber direction of 70% or more fibrous elements in the gas diffusion layer facing the gas flow channel.

In a seventh aspect of the present invention, a fuel cell is produced by laminating one or more single cells in the form of a single unit, the single cell comprising: an electrolyte membrane; a fuel electrode catalyst layer disposed on one surface of the electrolyte membrane; an air electrode catalyst layer disposed on the other surface of the electrolyte membrane; a first gas diffusion layer disposed on the outer surface of the fuel electrode catalyst layer; a second gas diffusion layer disposed on the outer surface of the air electrode catalyst layer; a first separator having a plurality of concave portions and convex portions forming one or more gas flow channels for reactant gas, the first separator being in contact with the outer surface of the first gas diffusion layer; a second separator having a plurality of concave portions and convex portions forming one or more gas flow channels for reactant gas, the second separator being in contact with the outer surface of the second diffusion layer; wherein the fuel cell is formed by clamping the above mentioned layer elements between the first and second separators to fasten the layer elements all together, wherein the first and second separators are fastened under the following condition:

D1×0.9≦D2

where D1 is the thickness of the gas diffusion layer before the separators are fastened and D2 is the thickness of the gas diffusion layer after the separators are fastened.

In accordance with the first and second aspects of the present invention, the fuel electrode catalyst layer and the air electrode catalyst layer are disposed on both surfaces of the electrolyte membrane, and the gas diffusion layers are further disposed on the outer surface of both the fuel electrode catalyst layer and air electrode catalyst layer, and a pair of separators having gas flow channels for reactant gas, each of said separators being disposed on the gas diffusion layer so as to face the gas diffusion layer, so that the fuel cell is produced by laminating one or more single cells, each of which is formed by fastening the above-mentioned layer elements to be clamped between the separators. In this case, the pressure loss in the case when the reactant gas flows into adjacent gas flow channels is set to be greater than the pressure loss in the case when water stayed in the gas flow channels is blown away by the reactant gas. As a result, the pressure loss in the gas flow channels can be reduced so as to maintain the essential pressure loss in the gas flow channels. Thus the water in the gas flow channels may be discharged in high efficiency, thereby enabling a stable generation of the electric power to be ensured for a long period under various operation conditions.

In accordance with the third aspect of the present invention, the fuel cell according to the first aspect of the present invention is designed such that the gas permeability inside the electrode in a direction perpendicular to the gas flow direction of the separators is smaller than the gas permeability inside the electrode in the gas flow direction and in the lamination direction. As a result, when the gas flow channels are clogged by the water droplets, the reactant gas supplied is prevented from flowing into the adjacent gas flow channels, thereby making it possible to efficiently discharge the droplets from the gas flow channels.

In accordance with the fourth aspect of the pr sent invention, the fuel cell according to one of the first to third aspects of the present invention is designed such that the fiber direction of the gas diffusion layers facing the separators is arranged approximately parallel to the gas flow direction of the separators, thereby making it possible to sufficiently prevent the supplied reactant gas from flowing into the adjacent gas flow channels via the gas diffusion layers.

In accordance with the fifth aspect of the present invention, the fuel cell according to one of the first to third aspects of the present invention is designed such that the gas flow direction in which the reactant gas flows in the gas flow channels possessing 50% or more of the entire gas flow channels on the one side of the separator is arranged approximately parallel to the fiber direction of the gas diffusion layers, so that the supplied reactant gas flows into the adjacent gas channels at a reduced rate after passing through the gas diffusion layers.

In accordance with the sixth aspect of the present invention, the fuel cell according to one of the first to third aspects of the present invention is designed such that the fiber direction of 70% or more of the fibers in the gas diffusion layers facing the corresponding separators is arranged approximately parallel to the gas flow direction in the separator, thereby making it possible to prevent the supplied reactant gas from flowing into the adjacent gas flow channels via the gas diffusion layers, while the strength and the shape stability of the gas diffusion layers remain unchanged.

In accordance with the seventh aspect of the present invention, the fuel electrode catalyst layer and the air electrode catalyst layer are disposed on both surfaces of the eletrolyte membrane, and the gas diffusion layers are further disposed on the outer surface of both the fuel electrode catalyst layer and air electrode catalyst layer, and a pair of separators having a plurality of concave portions and convex portions to form gas flow channels for reactant gas, each of said separators being disposed on the gas diffusion layer so as to face the gas diffusion layer. As a result, the fuel cell is produced by laminating one or more single cells, each of which is formed by clamping the above-mentioned layer elements between the convex portions of the separators to fasten the layer elements all together. In this case, the gas diffusion layers are selected such that D2 is D1×0.9 or smaller, where D1 is the thickness of the gas diffusion layer before fastened between the separators and that D2 is the thickness of the gas diffusion layer after fastened between the separators. This structural arrangement allows the reactant gas to be prevented from flowing into the adjacent gas channels via the gas diffusion layers clamped by the convex portions of the separators. As a result, a uniform reaction takes place in the surface of the electrode, so that the rated electric power can be obtained, and even if the gas flow channels are clogged by the water droplets condensed therein, these droplets can be discharged efficiently by the blow of the reactant gas.

Further objects, features and advantages of the present invention will become apparent from the following description of the preferred embodiments with reference to the accompanying drawings.

### BRIEF DESCRIPTION OF THE DRAWINGS

FIG. 1 is a partial sectional view schematically showing the structure of a solid polymer fuel cell in an embodiment of the invention;

FIG. 2 is a diagram showing the relationship between the specific thickness of the diffusion layer (%) and the fastening pressure

FIG. 3 is a partial sectional view schematically showing the structure of another solid polymer fuel cell according to the invention;

FIG. 4 is a perspective view for elucidating the flow direction of the reactant gas in a separator and the gas permeability of a gas diffusion layer or an electrode;

FIG. 5 is a perspective view for elucidating the relationship between the flow direction of the reactant gas in a separator and the direction of fibers in a gas diffusion layer;

FIG. 6 is an exploded sectional view of a solid polymer type fuel cell (single cell) for showing the basic structure of electrodes as an embodiment of a conventional fuel cell;

FIG. 7 is a sectional view of a solid polymer type fuel cell stack in the basic structural arrangement; and

FIG. 8 is a partially enlarged sectional view of the single fuel cell shown in FIGS. 6 and 7.

### DESCRIPTION OF THE PREFERRED EMBODIMENTS

Referring now to the accompanying drawings, the preferred embodiments of the present invention will be described.

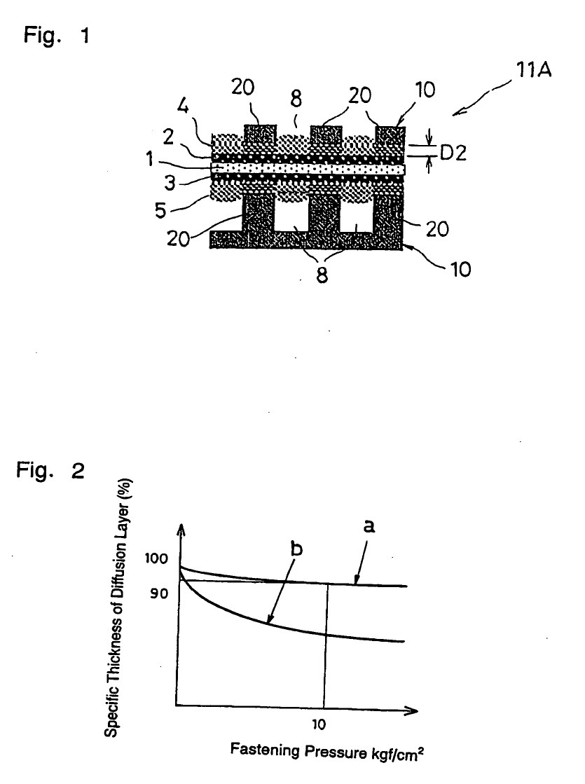

FIG. 1 is a partial sectional view schematically showing the structure of a solid polymer fuel cell.

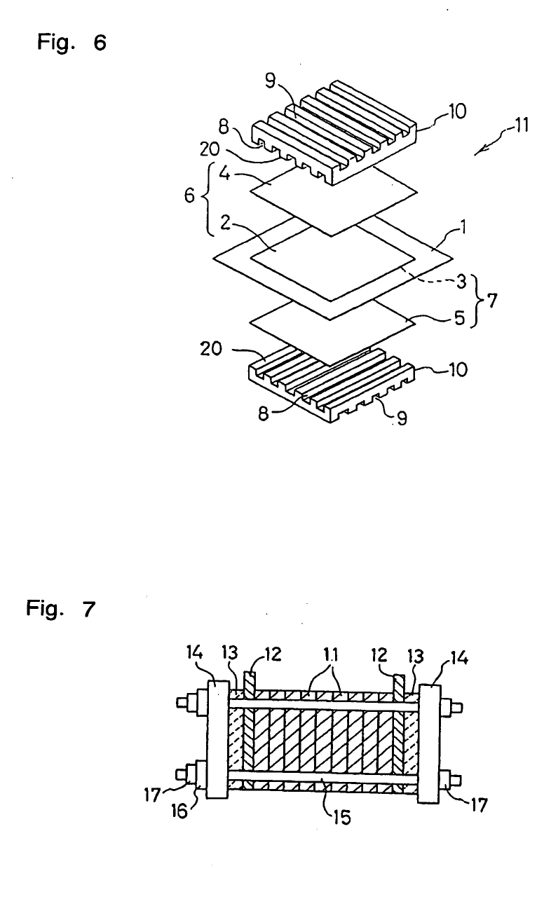

In FIG. 1, a single fuel cell 11A according to the invention has an air electrode catalyst layer 2 and a fuel electrode catalyst layer 3 deposited onto the main surfaces of a solid polymer electrolyte membrane 1 on both sides thereof, as similarly to that in FIG. 6. Moreover, a gas diffusion layer 4 for air electrode and another gas diffusion layer 5 for fuel electrode are disposed so as to face the air electrode catalyst layers 2 and the fuel electrode catalyst layer 3, respectively. Furthermore, separators 10 are disposed wherein each separator has a plurality of concave portions and convex portions 20 forming a gas flow channels 8 for the reactant gas flow disposed on the outer surface of the gas diffusion layer 4 and 5, so as to face the corresponding diffusion layers 4 and 5, and, moreover, wherein a cooling water flow channels 9 are disposed so as to face the main surface opposite to the gas flow channels. The single fuel cell 11A is formed by fastening the electrolyte membrane 1, the catalyst layers 2, 3 and the gas diffusion layers 4, 5 all together between the convex portions 20. Each of the gas diffusion layers 4 and 5 is selected such that it has a thickness D1 before fastened, i.e., in the state where fastening pressure is not applied and a thickness D2 after fastened, i.e., in the state where the fastening pressure is applied, in the relationship of D2 being D1×0.9 or less.

One or more single fuel cells 11A are clamped by separators 10, 10 disposed on both sides, and a cell stack is formed in a unified element by fastening the single fuel cells 11A with rods and end plates disposed on both end surfaces (see FIG. 7).

In the fuel cell (solid polymer type fuel cell) thus formed, a wet reactant gas is conducted to flow into the gas flow channels 8 of the separators 10 and to pass through the electrolyte membrane 1, where the electrochemical reaction takes place to generate the DC electric power.

In the above structural arrangement, the reactant gas is prevented from flowing into the adjacent gas flow channels via the gas diffusion layer clamped by the convex portions. As a result, a uniform reaction takes place inside the electrode surfaces so that the rated power can be obtained. Moreover, even if water droplets stay in the gas flow channel, they are discharged efficiently by the blow of the reactant gas.

FIG. 2 is a diagram showing the relationship between the specific thickness of the diffusion layer (%) and the fastening pressure.

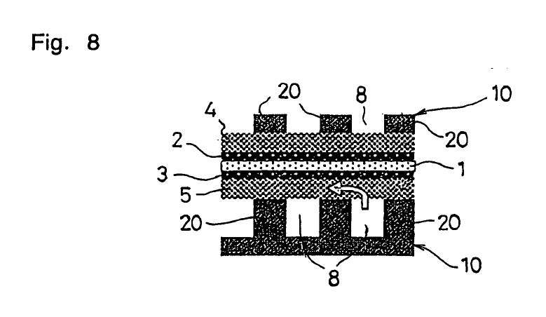

In FIG. 2, the 100% thickness of the diffusion layer implies the thickness D1 of the gas diffusion layer in the case when no fastening pressure is applied. The thickness of the diffusion layer gradually decreases with the increase of the fastening pressure, as shown in FIG. 2. The relationship between the diffusion layer thickness (%) and the fastening pressure for the conventional fuel cell electrode appears in a range on and over the curve a. In this case, for example, a fastening pressure of 10 kgf/cm² causes to provide a thickness corresponding to about 90% of the initial thickness. In the above range, part of the reactant gas flows into the adjacent gas flow channels 8 via the diffusion layer 5 which are clamped between the convex portions 20, as was already shown in FIG. 8.

On the other hand, curve b implies a relationship between the diffusion layer thickness (%) and the fastening pressure, which is recommended in the present invention. In this case, the fastening is carried out such that the thickness D2 of the diffusion layer after clamping becomes D1×0.9 or less under a predetermined fastening pressure (for example 10 kgf/cm²), where D1 is the thickness before clamping.

In such a structural arrangement, the gas diffusion layers 4 and 5 clamped between the convex portions 20 provide a reduced magnitude in the gas permeability. When, however, no fastening pressure or almost no fastening pressure is applied to the gas flow channels 8, the gas diffusion layers 4 and 5 provide an increased magnitude in the gas permeability. A greater difference between the magnitudes in the two states causes the reactant gas to be suppressed or precluded from flowing into the adjacent gas flow channels 8 via the gas diffusion layers 4 and 5 clamped between the convex portions 20, thereby enabling the reactant gas to be uniformly flowed into each of the gas flow channels 8.

Accordingly, even if droplets are condensed in the gas flow channels 8, they are removed therefrom by the blow of the reactant gas, thereby making it possible to efficiently discharge the condensed droplets from the gas flow channels 8.

Furthermore, the fastening pressure is applied to the gas diffusion layers 4 and 5 between the convex portions 20, so that the layers are compressed in a highest strength. This causes to reduce the contact resistance.

As for the gas diffusion layers 4 and 5 used in the present invention, there are no special limitations: For instance, a conductive porous material including fibrous porous elements composed of carbon paper, carbon woven fabric, carbon non-woven fabric prepared, using petroleum, polyacrylonitrile, or cellulose carbon fibers or metallic fibers; a material prepared by applying the water repellent finishing to the conductive porous material; and a material prepared by coating to said conductive porous material a mixture of carbon powder and water repellent filler, such as polytetrafluoroethylene, perfluorocarbon sulfonic acid, tetrafluoroethylene-perfluoroalkylvinylethylene copolymer, tetrafluoroethylene-hexafluoropropylene copolymer, polychlorotrifluoroethylene, polyvinylidene fluoride, polyvinyl fluoride and tetrafluoroethylene-ethylen copolymer, can be employed.

The gas diffusion layers prepared from a carbon paper having high elasticity, a carbon paper including fine fibers or a material including a water-repellent filler, such as tetrafluoroethylene, at an optimal content in the electrolytic porous material securely provides a thickness of 90% or less with respect to the initial thickness with a predetermined fastening pressure (for example, the normally used fastening pressure of 10 kgf/cm²), so that such gas diffusion layers can be preferably employed in the present invention in order to prevent the reactant gas from flowing into the adjacent gas flow channels.

In the present invention, although such special gas diffusion layers are advantageously used, a conventional gas diffusion layer may also be employed so long as it is possible to increase the fastening pressure in such a way that the thickness reduction of 90% or less with respect to the initial thickness is attained.

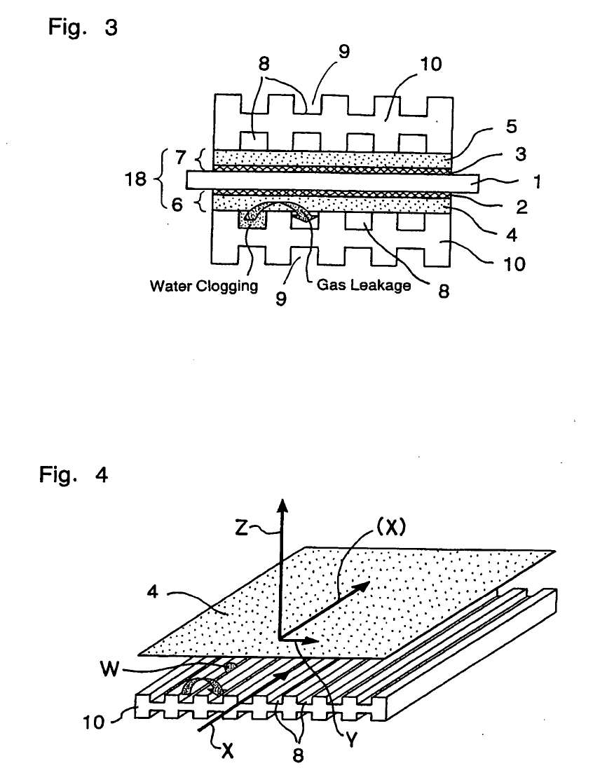

FIG. 3 is a partial sectional view schematically showing the structure of another solid polymer fuel cell according to the invention. FIG. 4 is a perspective view for elucidating the flow direction of the reactant gas in a separator and the gas permeability of a gas diffusion layer or an electrode.

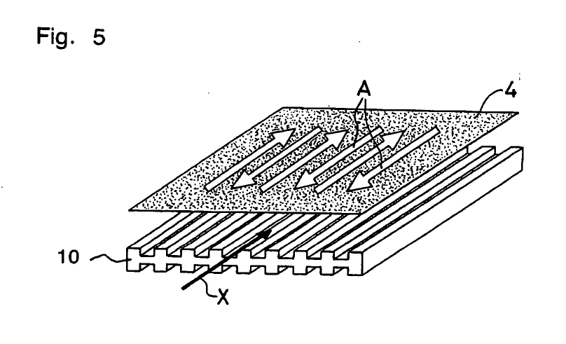

FIG. 5 is a perspective view for elucidating the relationship between the flow direction of the reactant gas in a separator and the direction of fibers in a gas diffusion layer.

In FIG. 3, reference numeral 18 means a cell unit (membrane electrode assembly: MEA), which is formed in a single unified element by joining a solid electrolyte membrane 1, a fuel electrode 7 disposed on one surface of the electrolyte membrane 1 and an air electrode 6 disposed on the other surface to each other. In this case, the cell unit 18 is clamped on both sides by the separators 10, 10.

The separator 10 has reactant gas flowing channels 8 facing either the gas diffusion layers 4 or 5 on one side of the main body, and cooling water flowing channels 9 on the opposite side of the main body, and the separator is made of an electrical conductive gas impermeable material. A fuel gas, such as hydrogen or hydrogen-rich reforming gas, flows in the gas flow channels 8 facing the fuel electrode 7, whereas an oxidizer, such as air or the like flows in the gas flow channels 8 facing the air electrode 6.

The fuel electrode 7 is constituted by the gas diffusion layer 5 made of a thin carbon paper or the like and by the catalyst layer 3 made of both ion exchanger (polymer electrolyte) and carbon particles including noble metal such as platinum or the like or alloy thereof in the gas diffusion layer 5 on one side of the electrolyte membrane 1, whereas the air electrode 6 is constituted by the gas diffusion layer 4 made of a thin carbon paper or the like and by the catalyst layer 2 made of both ion exchanger (polymer electrolyte) and carbon particles including noble metal such as platinum or the like alloy thereof in the gas diffusion layer 4 on the other side of the electrolyte membrane 1.

A cell stack (see FIG. 7) is formed in a unified element by laminating one or more cell units 18 in the state in which each cell unit 18 is clamped on both sides with the separators 10, 10, and subsequently by clamping the cell units thus laminated and further by fastening the end plates disposed on both ends of cell units with rods.

The fuel cell (solid polymer type fuel cell) thus formed is capable of generating a DC electric power by flowing the wet reactant gas into the gas flow channels 8 of the separator 10, as similarly to the conventional apparatus, and at the same time by the electrochemical reaction which takes place in the state of passing through the electrolyte membrane 1.

As shown in FIG. 4, part of reactant gas (oxidant gas) flowing, for instance, in the gas flow channels 8 of the separator 10 in the direction X flows into the adjacent gas flow channels in the direction Y orthogonal to the flow direction X via the gas diffusion layer 4 for the air electrode 6, whereas the other part of reactant gas flows in the lamination direction Z (toward the electrolyte membrane 1). In the present invention, the cell unit is designed such that the permeability (osmotic coefficient) of the reactant gas diffusing in the Y direction is smaller than the permeability (osmotic coefficient) of the reactant gas, which flows in the gas flow direction X and diffuses in the lamination direction Z.

In order to attain the above design concept, the gas diffusion layer 4 for the air electrode 6 is arranged in such a way that the fibers in the gas diffusion layer 4 are arranged in the direction A approximately parallel to the gas flow direction X as shown in FIG. 5.

In this structural arrangement, there exist fibers in the gas diffusion layer 4 arranged in the gas flow direction X at a high density in the area of the air electrode 6 covering the gas flow channels 8 of the separator 10. As a result, the reactant gas diffused into the gas diffusion layer 4 flows in a much higher diffusion rate in the lamination direction Z and in the gas flow direction X. However, it is difficult for the reactant gas to diffuse in the orthogonal direction Y. Consequently, a much larger pressure loss may be obtained for the gas flowed into the adjacent gas flow channels 8. In other words, the pressure loss in the gas flow direction X can be reduced in the gas flow channels 8 of the separator 10. Accordingly, water droplets W deposited on the inner surface of the gas flow channels 8 or plugging the channels 8 may be blown away, and therefore may be discharged therefrom.

Similarly on the side of the fuel electrode 7, the gas diffusion layer 5 for the fuel electrode 7 is arranged in such a way that the fibers in the gas diffusion layer 5 are arranged in the direction approximately parallel to the gas flow direction X. In this structural arrangement, there exist fibers in the gas diffusion layer 5 arranged in the gas flow direction X at a high density in the area of the fuel electrode 7 covering the gas flow channels 8 of the separator 10. As a result, the reactant gas (fuel gas) diffused into the gas diffusion layer 5 flows in a much high r diffusion rate in direction Z toward the electrolyte membrane 1 and in the gas flow direction X. However, it is difficult for the reactant gas to diffuse in the orthogonal direction Y. Consequently, a much larger pressure loss may be obtained for the gas flowed into the adjacent gas flow channels 8, and the pressure loss in the gas flow direction can be reduced in the gas flow channels 8 of the separator 10. Accordingly, water droplets deposited onto the inner surface of the gas flow channels 8 or plugging the channels 8 may be blown away and therefore may be discharged therefrom.

Regarding the measurement of pressure loss in the gas flow channels, the following tests were carried out, using separators, which were each equipped with three straight line-shaped gas flow channels having an arbitrary length, as well as the same material and the same dimension (the gas flow channel depth, the gas flow channel width and the pitch between the gas flow channels) as those in the separator used in the actual fuel cell. In this case, a cell unit was placed on the separator and further an elaborate flat plate was placed on the cell unit, and then the member thus prepared was fastened with the same fastening pressure as in the actual fuel cell. The measurement was carried out under a condition that the gas was flowed only in the center gas flow channel. In addition, the following method (1) was applied to the measurement of the pressure loss in the case when the water droplets in the gas flow channels were blown away, and the following method (2) was applied to the measurement of the pressure loss in the case when the gas leaked into the adjacent gas flow channels:

(1) Water droplets having a predetermined size were disposed in the vicinity of the rear end of the center gas flow channel, and either the gas flow channels adjacent to the center gas flow channel were clogged at the inlet and outlet, or the adjacent gas flow channels was filled with a silicone sealant over the entire length. The pressure losses at both the inlet and outlet of the center gas flow channel were measured under an increased gas pressure, when the water droplets were discharged.

(2) Water droplets were disposed in the center gas flow channel, as similarly in the method (1), and the center gas flow channel was clogged at the outlet while the adjacent gas flow channels were released. The pressure losses at the inlet of the center gas flow channel and at the outlet of the adjacent gas flow channels were measured under an increased gas pressure, when the gas leaked into the adjacent gas flow channels.

Although the straight line-shaped gas flow channels of the separator were used in the above embodiment, curved gas flow channels in the form of S-shape, which are not shown, can also be employed. In such a case, it is found that water in the gas flow channels may be discharged at high efficiency, if the gas flow direction in which gas flows in the gas flow channels having 50% or more of the entire gas flow channels on one side of the separator is arranged in the direction approximately parallel to the direction of the fibers in the gas diffusion layer.

Moreover, in the case of the curved gas flow channels, the cell unit is designed such that the gas flow direction in the separator is arranged in direction approximately parallel to the direction of fibers in the gas diffusion layer at the area facing each gas flow channel. That is, if the fiber direction at each portion of the gas diffusion layer is also arranged in the curved direction in accordance with the gas flow channels facing the gas diffusion layer, the water droplets may be discharged from the gas flow channels at a further higher efficiency.

Actually, it is difficult to align all of the fibers in the gas diffusion layer in the same direction to preserve the strength and the shape of the gas diffusion layer, and there is a possible existence of the fibers arranged in deviated directions due to the variation in the production. In view of this fact, it is found that water droplets may be discharged in high efficiency from the gas flow channels, and the strength and shape stability of the gas diffusion layer is preserved, if there exist 70% or more of the fibers in the gas diffusion layer facing the separator where the arranged direction of the fibers is approximately parallel to the gas flow direction in the separator.

In another embodiment, using, for example, the arrangement shown in FIG. 1, it is possible to reduce the pressure loss at the gas flow channels, if the pressure loss where the reactant gas flows into the adjacent gas flow channels is set to be smaller than the pressure loss where the water clogged in the gas flow channels are blown away by the reactant gas, so that water may be discharged in high efficiency from the gas flow channels since the actual pressure loss is preserved in the gas flow channels. As a result, a stable generation of electric power may be realized during a long period under various operation conditions.

While preferred embodiments have been shown and described, various modifications and substitutions may be made without departing from the spirit and scope of the invention. Accordingly, it is to be understood that the present invention has been described by way of examples, and not by limitations.

### INDUSTRIAL APPLICABILITY

As described above, in the fuel cell according to the present invention, the pressure loss in the case when the reactant gas flows into adjacent gas flow channels is set to be greater than the pressure loss in the case when water stayed in the gas flow channels is blown away by the reactant gas. As a result, the essential pressure loss in the gas flow channels is maintained, so that the water in the gas flow channels may be discharged in high efficiency, thereby enabling a stable power generation to be ensured for a long period under various operation conditions.

Moreover, in the fuel cell according to the present invention, the gas diffusion layers are selected such that D2 is D1×0.9 or smaller where D1 is the thickness of the gas diffusion layer before fastened between the separators and D2 is the thickness of the gas diffusion layer after fastened between the separators. This structural arrangement allows the reactant gas to be prevented from flowing into the adjacent gas channels via the gas diffusion layers clamped by the convex portions of the separators. As a result, a uniform reaction takes place in the surface of the electrode, so that the rated electric power can be obtained, and even if the gas flow channels are clogged by the water droplets condensed therein, these droplets can be discharged by the blow of the reactant gas.

### Figure Caption

FIG. 2:

Fastening Pressure kgf/cm²

Specific Thickness of Diffusion Layer (%)

FIG. 3:

Water Plugging

Gas Leakage

What is claimed is:

1. A fuel cell integrated by laminating one or more single cells in the form of a single unit, said single cell comprising:
an electrolyte membrane;
a fuel electrode catalyst layer disposed on one surface of said electrolyte membrane;
an air electrode catalyst layer disposed on the other surface of said electrolyte membrane;
a first gas diffusion layer disposed on the outer surface of said fuel electrode catalyst layer;
a second gas diffusion layer disposed on the outer surface of said air electrode catalyst layer;
a first separator having one or more gas flow channels for reactant gas, said first separator being in contact with the outer surface of said first gas diffusion layer;
a second separator having one or more gas flow channels for reactant gas, said second separator being in contact with the outer surface of said second diffusion layer;
wherein said single cell is formed by clamping said layer elements to fasten said layer elements all together,
wherein said fuel cell is equipped with means for restraining a reactant gas flowing into adjacent gas flow channels via said first or said second gas diffusion layer in order to prevent the generation of water droplets plugging said gas flow channels.

2. A fuel cell according to claim 1, wherein the generation of water droplets plugging said gas flow channels is suppressed by setting the pressure loss of the reactant gas flowing into adjacent gas flow channels via said gas diffusion layer greater than the pressure loss of the reactant gas blowing away the water stayed in the gas flow channels.

3. A fuel cell according to claim 1, wherein, in said first gas diffusion layer and/or in said second gas diffusion layer, the gas permeability in the direction perpendicular to the gas flow direction and parallel to the surface of said separators is smaller than the gas permeability in the gas flow direction and in the lamination direction of said single cells.

4. A fuel cell according to any one of claims 1 to 3, wherein said first and second gas diffusion layers include fibrous elements, and wherein the gas flow direction in said gas flow channels is approximately parallel to the fiber direction of said fibrous elements in said first and second gas diffusion layers facing said gas flow channels.

5. A fuel cell according to any one of claims 1 to 3, wherein said first and second gas diffusion layers include fibrous elements, and wherein the gas flow direction for the gas flow channels possessing 50% or more areas of all the gas flow channels in said separator is arranged approximately parallel to the fiber direction of said fibrous elements in said gas diffusion layers facing said separator.

6. A fuel cell according to any one of claims 1 to 3, wherein said first and second gas diffusion layers include fibrous elements, and wherein the gas flow direction in said separator is arranged approximately parallel to the fiber direction of 70% or more fibrous elements in said gas diffusion layers facing said gas flow channel.

7. A fuel cell produced by laminating one or more single cells in the form of a single unit, said single cell comprising:
an electrolyte membrane;
a fuel electrode catalyst layer disposed on one surface of said electrolyte membrane;
an air electrode catalyst layer disposed on the other surface of said electrolyte membrane;
a first gas diffusion layer disposed on the outer surface of said fuel electrode catalyst layer;
a second gas diffusion layer disposed on the outer surface of said air electrode catalyst layer;
a first separator having one or more concave portions and convex portions forming one or more gas flow channels for reactant gas, said first separator being in contact with the outer surface of said first gas diffusion layer;
a second separator having one or more concave portions and convex portions forming one or more gas flow channels for reactant gas, said second separator being in contact with the outer surface of said second diffusion layer;
wherein said fuel cell is formed by clamping said layer elements between said first and second separators to fasten said layer elements all together,
wherein a pair of said first and second separators are fastened under the following condition:
D1×0.9≧D2
where D1 is the thickness of said gas diffusion layer before said separators are fastened, and D2 is the thickness of said gas diffusion layer after said separators are fastened.
